(19) United States
(12) Patent Application Publication
(10) Pub. No.: US 2016/0276923 A1
(43) Pub. Date: Sep. 22, 2016

(54) SNUBBER CIRCUIT

(71) Applicant: SANKEN ELECTRIC CO., LTD., Niiza-Shi (JP)

(72) Inventors: Akira HAYAKAWA, Fujimino-Shi (JP); Masaaki SHIMADA, Fujimi-Shi (JP); Koji IKEDA, Fujimino-Shi (JP)

(73) Assignee: SANKEN ELECTRIC CO., LTD., Niiza-Shi (JP)

(21) Appl. No.: 14/970,742

(22) Filed: Dec. 16, 2015

(30) Foreign Application Priority Data
Mar. 17, 2015 (JP) 2015-053211

(51) Int. Cl. H02M 1/34; H02M 3/335

(52) U.S. Cl. CPC H02M 1/34; H02M 3/33507

(57) ABSTRACT

An embodiment of a snubber circuit that absorbs a surge voltage generated in a transformer of a switching power supply, comprises a diode, a zener diode electrically connected to the diode, and a first capacitor electrically connected to the zener diode. The diode, the zener diode, and the first capacitor are serially connected such that, at occurrence of the surge voltage, the diode operates in a forward direction and the first capacitor is charged with the surge voltage via a breakdown voltage of the zener diode, and the diode has reverse recovery time that is longer than a half of a cycle of a ringing voltage generated in a winding of the transformer and is in a range of 125 ns to 7 μs.

### CROSS REFERENCE TO RELATED APPLICATIONS

This application claims priority based on 35 USC 119 from prior Japanese Patent Application No. 2015-053211 filed on Mar. 17, 2015, entitled “SNUBBER CIRCUIT”, the entire contents of which are hereby incorporated by reference.

### BACKGROUND

This disclosure relates to a snubber circuit that absorbs a surge voltage generated at turning-off of a switching element in a switching power supply.

A surge absorption (snubber) circuit including a surge absorption capacitor, a rectification diode, and a resistor is disclosed (for example, refer to Japanese Patent No. 3374916 (refer to Patent document 1)) . According to Patent document 1, a reverse recovery (recovery) time of the rectification diode is set to be longer than a half of a cycle of a ringing voltage that occurs in a winding of a transformer, be shorter than a minimum OFF period of a switching element, and be in a range of 125 ns to 7 μs. With this setting, the ringing voltage is suppressed or prevented from occurring in the winding of the transformer and further, and charges in the surge absorption capacitor after surge absorption are discharged via the winding in the reverse recovery time of the rectification diode, thereby regenerating power on an output side or a power supply side to improve efficiency.

### SUMMARY

An embodiment of a snubber circuit that absorbs a surge voltage generated in a transformer of a switching power supply, comprises a diode, a zener diode electrically connected to the diode, and a first capacitor electrically connected to the zener diode. The diode, the zener diode, and the first capacitor are serially connected such that, at occurrence of the surge voltage, the diode operates in a forward direction and the first capacitor is charged with the surge voltage via a breakdown voltage of the zener diode, and the diode has reverse recovery time that is longer than a half of a cycle of a ringing voltage generated in a winding of the transformer and is in a range of 125 ns to 7 μs.

### BRIEF DESCRIPTION OF DRAWINGS

FIG. 1 is a diagram illustrating a switching power supply including a snubber circuit in an embodiment;

FIG. 2 is a waveform chart illustrating a snubber current, a drain-source voltage, and a drain current in the switching power supply illustrated in FIG. 1;

FIG. 3A, 3B, and 3C are waveform charts illustrating details of the snubber current illustrated in FIG. 2;

FIG. 4 is a circuit diagram illustrating a configuration of a conventional snubber circuit;

FIGS. 5A, 5B, 5C, and 5D are circuit diagrams illustrating configurations of the snubber circuits in other embodiments; and

FIG. 6 is a waveform chart illustrating a snubber current, a drain-source voltage, and a drain current in a switching power supply including the snubber circuit illustrated in FIG. 5B.

### DETAILED DESCRIPTION

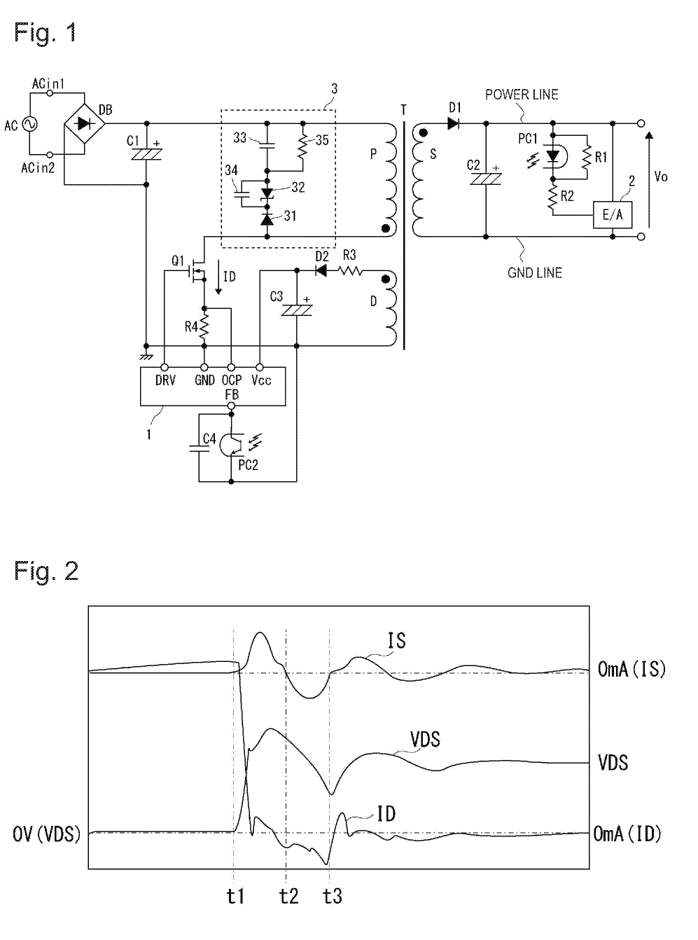

Referring to FIG. 1, a switching power supply including snubber circuit 3 in this embodiment includes rectification circuit DB, smoothing capacitors C1, C2, C3, transformer T, switching element Q1, controller IC1, rectification diodes D1, D2, error amplifier (E/A) 2, light emitting diode PC1 and light reception transistor PC2 that constitute photocoupler, resistors R1, R2, R3, and capacitor C4.

Commercial AC power supply AC is connected to AC input terminals ACin1, ACin2 of rectification circuit DB with a diode bridge configuration, and an input voltage from commercial AC power supply AC is full-wave rectified and outputted from rectification circuit DB. Smoothing capacitor C1 is connected between a rectified output positive terminal and a rectified output negative terminal of rectification circuit DB. The rectified output negative terminal of rectification circuit DB is connected to a ground terminal. Rectification circuit DB and smoothing capacitor C1 function as a DC power supply, and an input voltage from commercial AC power supply AC is rectified and smoothed by rectification circuit DB and smoothing capacitor C1 to acquire a DC voltage.

Controller IC1 includes a control circuit which is connected to a gate terminal of switching element Q1 including a power MOSFET (Metal Oxide Semiconductor Field Effect Transistor) or the like, which includes a DRV (drive signal output) terminal that outputs a drive signal for controlling ON/OFF of switching element Q1, a FB (feedback signal input) terminal, an OCP (overcurrent detection) terminal, and a GND terminal, and which is configured to control switching of switching element Q1.

Transformer T that feeds power from the primary side (input side) to the secondary side (load side) includes primary winding P, auxiliary winding D, and secondary winding S, and the rectified output positive terminal of rectification circuit DB is connected to one end of primary winding P of transformer T. The other end of primary winding P of transformer T is connected to a drain terminal of switching element Q1, and a source terminal of switching element Q1 is connected to the OCP (overcurrent detection) terminal of controller IC1 as well as a ground terminal and the GND terminal of controller IC1 via resistor R4 for current detection. Controller IC1 controls ON/OFF of switching element Q1, thereby transmitting power fed to primary winding P of transformer T to secondary winding S of transformer T to generate a pulse voltage in secondary winding S of transformer T.

Smoothing capacitor C2 is connected between both terminals of secondary winding S of transformer T via rectification diode D1. Rectification diode D1 and smoothing capacitor C2 function as a secondary rectification and smoothing circuit. A voltage induced in secondary winding S of transformer T is rectified and smoothed by rectification diode Dl and smoothing capacitor C2, and a voltage between terminals of smoothing capacitor C2 is outputted as output voltage Vo from an output terminal. A line connected to the positive terminal of smoothing capacitor C2 serves as a power line, and a line connected to the negative terminal of smoothing capacitor C2 serves as a GND line connected to the ground terminal.

Error amplifier 2 is serially connected between the power line and the GND line of output voltage Vo. Error amplifier 2 is connected between the power line and the GND line of output voltage Vo, compares output voltage Vo with a reference voltage, and controls a current flowing through light emitting diode PC1 of the photocoupler according to an error voltage between output voltage Vo and the reference voltage. A FB terminal of controller IC1 is connected to the ground terminal via light emitting diode PC1 and capacitor C4 which are connected in parallel. Thus, a feedback (FB) signal corresponding to the error voltage between output voltage Vo and the reference voltage is sent from light emitting diode PC1 on the secondary side to light reception transistor PC2 on the primary side, and is inputted as FB voltage VFB to the FB terminal of controller IC1. Controller IC1 controls the duty ratio of switching element Q1 on the basis of FB voltage VFB inputted to the FB terminal to control the amount of power fed to the secondary side.

Smoothing capacitor C3 is connected between both terminals of auxiliary winding D of transformer T via resistor R3 and rectification diode D2, and a junction of rectification diode D2 and smoothing capacitor C3 is connected to a Vcc terminal of controller IC1. Thus, a voltage generated in auxiliary winding D is rectified and smoothed by rectification diode D2 and smoothing capacitor C3, and is fed as IC power voltage Vcc to the Vcc terminal of controller IC1.

Snubber circuit 3 includes diode 31, zener diode 32, capacitors 33, 34, and resistor 35. A series circuit including diode 31, zener diode 32, and capacitor 33 is connected to primary winding P in parallel, capacitor 34 is connected to zener diode 32 in parallel, and resistor 35 is connected to capacitor 33 in parallel. An anode of diode 31 is connected to a junction of primary winding P and the drain terminal of switching element Q1, and a cathode of zener diode 32 is connected to a cathode of diode 31. One end of capacitor 33 and one end of resistor 35 are connected between an anode of zener diode 32, and a junction of the rectified output positive terminal of rectification circuit DB and primary winding P. That is, diode 31 is connected to be biased in a forward direction with the voltage of primary winding P at turning-off of switching element Q1, and zener diode 32 is connected to be biased in a reverse direction with the voltage of primary winding P at turning-off of switching element Q1.

Diode 31 functions as a voltage-proof protection diode, and has a recovery property that the reverse recovery time is set in the range of 125 ns to 7 μs, which is longer than that of a typical diode. The reverse recovery time of diode 31 has a value that is larger than a half of a cycle of a ringing voltage generated without snubber circuit 3, and smaller than a minimum OFF period of switching element Q1. The cycle of ringing voltage means a cycle of a ringing component of the drain-source voltage of switching element Q1, and a frequency of the ringing voltage is sufficiently higher than an ON/OFF frequency of switching element Q1, for example, 20 to 150 kHz. The minimum OFF period means one shortest OFF time that can be taken by switching element Q1. The Diode SARS series manufactured by SANKEN ELECTRIC CO., LTD can be adopted as diode 31 that satisfies such reverse recovery time.

A breakdown (zener) voltage of zener diode 32 is set based on a flyback voltage (voltage that is larger than the product of a turns ratio of primary winding P to secondary winding S multiplied by output voltage Vo) excluding the surge voltage generated in primary winding P. Zener diode 32 is a clamp element that forcedly clamps the flyback voltage generated in primary winding P. Zener diode 32 can reduce, by the flyback voltage, the voltage to be applied to the CR snubber including capacitor 33 and resistor 35.

Capacitor 33 and capacitor 34 function as surge absorption capacitors that absorbs the surge voltage generated in primary winding P at turning-off of switching element Q1. The surge voltage generated at stand-by and light load operation is mainly absorbed by capacitor 34. The surge voltage generated at a steady load and heavy load is absorbed by both of capacitor 34 and capacitor 33. A capacitance of capacitor 34 parallelly connected to zener diode 32 is set to 100 pF to 1000 pF, and a capacitance of capacitor 33 serially connected to zener diode 32 is set equal to the capacitance of capacitor 34 or more. Zener diode 32 has a junction capacitance, and the junction capacitance of zener diode 32 is parallelly connected to capacitor 34. A junction capacitance of a typical zener diode is several tens of pF, and a sum of the junction capacitance of zener diode 32 and the capacitance of capacitor 34 is preferably about 500 pF (400 to 600 pF). When the junction capacitance of zener diode 32 can be set to 100 pF to 1000 pF, capacitor 34 may be omitted.

Resistor 35 is a discharge resistor that discharges the surge voltage (charges) absorbed by capacitor 33.

FIG. 2 illustrates snubber current IS flowing through snubber circuit 3 (diode 31), drain-source voltage VDS of switching element Q1, and drain current ID flowing through switching element Q1, at turning-off of switching element Q1 in a switching power supply including snubber circuit 3 in this embodiment. In this snubber circuit, the capacitances of capacitor 33 and capacitor 34 each are 470 pF, and the resistance value of resistor 35 is 300 KΩ. The junction capacitance of zener diode 32 is 40 pF.

As illustrated in FIG. 2, snubber current IS starts to flow with a little delay after time t1 when switching element Q1 is turned off, a surge voltage generated in primary winding P is absorbed by capacitors 33, 34 and clamped with the voltage of capacitors 33, 34, and drain-source voltage VDS is also limited. When the voltage of capacitor 33, 34 rises due to absorption of the surge voltage, a reverse voltage is applied to diode 31. Since diode 31 has the recovery property that the reverse recovery time is longer than that of the typical diode, even when the reverse voltage is applied, diode 31 keeps its conducting state, and as illustrated, snubber current IS reversely flows in a period from time t2 to t3. In the period from time t2 to time t3, a stray capacitance of primary winding P and switching element Q1 is parallelly connected to a dynamic impedance of zener diode 32 and capacitors 33, 34, forming a resonance circuit having a sufficiently low frequency. This suppresses ringing of drain-source voltage VDS.

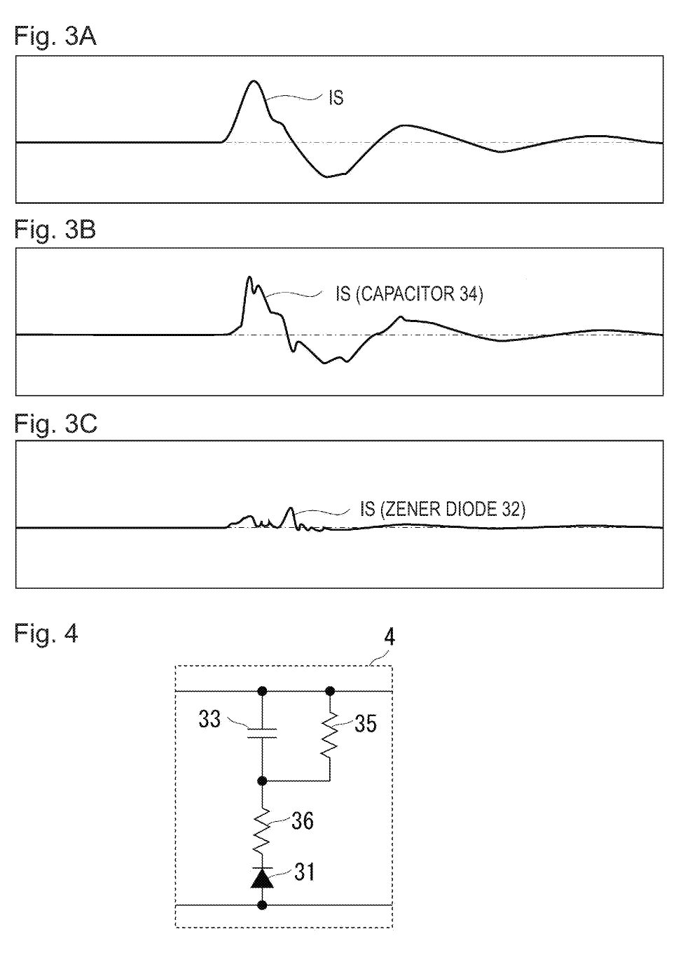

FIG. 3A illustrates snubber current IS flowing through snubber circuit 3, FIG. 3B illustrates a current flow through capacitor 34 included in snubber current IS, and FIG. 3C illustrates a current flow through zener diode 32 included in snubber current IS, at turning-off of switching element Q1. Snubber current IS illustrated in FIGS. 3 is measured at stand-by or light load operation, and most of the snubber current IS mainly flows through capacitor 34. That is, zener diode 32 only acts as a trigger of flowing of the current. Accordingly, at stand-by and light load operation, most of the surge voltage is absorbed by capacitor 34. The surge voltage absorbed by capacitor 34 can be regenerated in the reverse recovery time of diode 31 without being consumed by resistor 35 and the dynamic impedance of zener diode 32, and can be applied to secondary winding S via primary winding P of transformer T to feed regenerated energy to the secondary side.

Next, to verify the loss reduction effect of snubber circuit 3 in this embodiment, a loss is measured using conventional snubber circuit 4 (Patent document 1) as illustrated in FIG. 4. As a result, a loss in conventional snubber circuit 4 is 17 mW, while a loss in snubber circuit 3 in this embodiment is 1.5 mW, which means a reduction of about 90% compared to the loss in conventional snubber circuit 4.

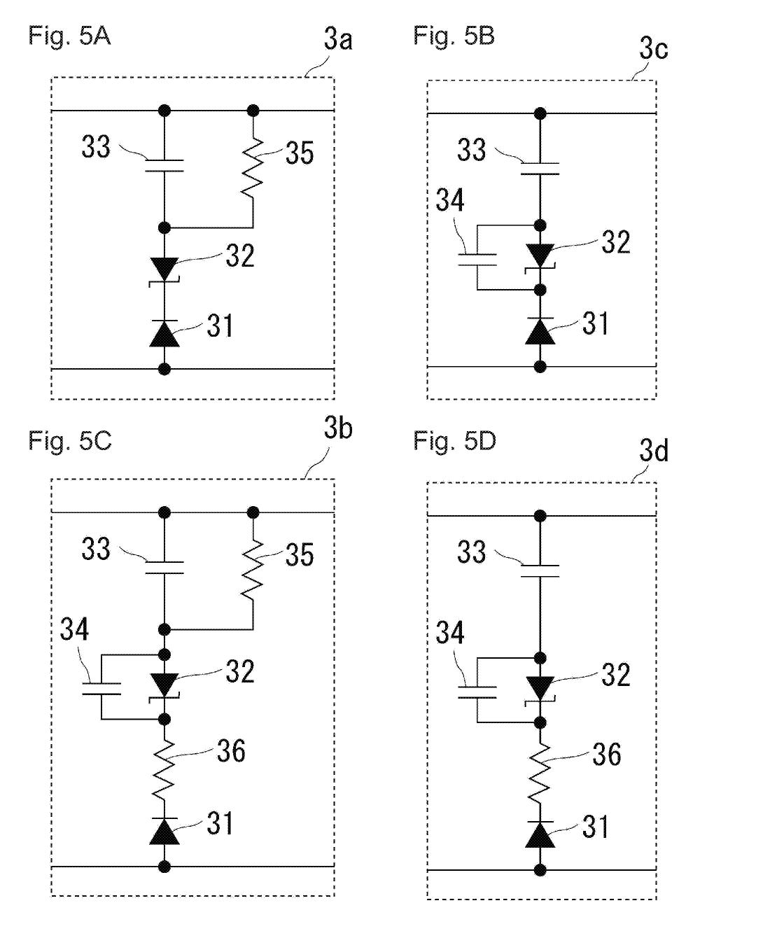

Next, as illustrated in FIG. 5A, a loss is measured using snubber circuit 3a formed by adding zener diode 32 to conventional snubber circuit 4. As a result, a loss in snubber circuit 3a is 2.5 mW. This demonstrates that only adding zener diode 32 can reduce the loss. However, by connecting capacitor 34 to zener diode 32 in parallel as in snubber circuit 3 in FIG. 1, the loss can be further reduced. It is considered this is because all of the surge voltage is absorbed and regenerated via the dynamic impedance of zener diode 32 in snubber circuit 3a.

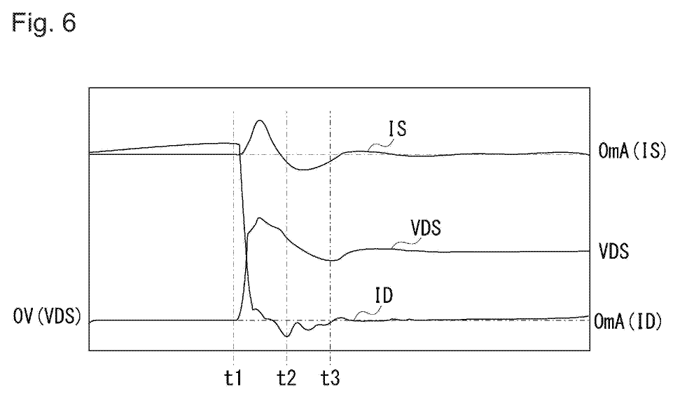

In this embodiment, to remove oscillation of drain-source voltage VDS as much as possible to acquire a flat property, as illustrated in FIG. 5B, snubber circuit 3b, in which resistor 36 having a resistance value of about 10 to 470Ω is connected between diode 31 and zener diode 32, may be adopted. FIG. 6 illustrates snubber current IS flowing through snubber circuit 3 (diode 31), drain-source voltage VDS of switching element Q1, and drain current ID flowing through switching element Q1, at turning-off of switching element Q1 in a switching power supply including snubber circuit 3b. In this snubber circuit, the capacitances of capacitor 33 and capacitor 34 each are 470 pF, a resistance value of resistor 35 is 300 KΩ, and a resistance value of resistor 36 is 100Ω. The junction capacitance of zener diode 32 is 40 pF. FIG. 6 demonstrates that oscillation of drain-source voltage VDS is reduced.

In this embodiment, in the case of a charger or adaptor with a small output power of about 5 W, as illustrated in FIG. 5C, snubber circuit 3c without resistor 35 in snubber circuit 3 illustrated in FIG. 1 may be adopted. Alternatively, as illustrated in FIG. 5D, snubber circuit 3d without resistor 35 in snubber circuit 3b illustrated in FIG. 5B may be adopted. For power saving output, saving of stand-by power is required, and a loss of resistor 35 may be eliminated.

As described above, in this embodiment, in snubber circuit 3 that absorbs the surge voltage generated in transformer T of the switching power supply, diode 31, zener diode 32, and capacitor 33 are serially connected such that, at occurrence of the surge voltage, diode 31 operates in a forward direction, and capacitor 33 is charged with the surge voltage via the breakdown voltage of zener diode 32, and the reverse recovery time of diode 31 is set to be longer than a half of a cycle of the ringing voltage generated in the winding of transformer T and be in a range of 125 ns to 7 μs.

Since zener diode 32 suppresses the voltage to be applied to capacitor 33, a loss at stand-by or light load operation can be reduced, this configuration can realize improvement in the efficiency of a stand-by region (to meet energy conservation standards). In addition, since the surge voltage charged in capacitor 33 is regenerated in the long reverse recovery time of diode 31, ringing can be suppressed to effectively counteract the EMI (Electro-Magnetic Interference).

Further, in this embodiment, capacitor 34 having a capacitance of 100 pF to 1000 pF is connected to zener diode 32. The sum of the capacitance of capacitor 34 and the junction capacitance of zener diode 32 is 400 pF to 1000 pF. The capacitance of capacitor 33 is set equal to the capacitance of capacitor 34 or more.

With this configuration, since most of the snubber current IS flows through capacitor 34 at stand-by and light load operation, the surge voltage absorbed by capacitor 34 is regenerated in the reverse recovery time of diode 31 without flowing through resistor 35 and the dynamic impedance of zener diode 32. Therefore, a loss at stand-by or light load operation can be further reduced, which realizes more effective improvement in the efficiency of the stand-by region (to meet energy conservation standards).

Further, in this embodiment, the junction capacitance of zener diode 32 can be set to 100 pF to 1000 pF.

This configuration requires no capacitor 34.

Further, in this embodiment, resistor 36 having a resistance value of 10Ω to 470Ω can be serially connected to zener diode 32.

This configuration can remove oscillation of drain-source voltage VDS as much as possible to acquire a flat property.

Although the invention has been described using the specific embodiments, the embodiments are only examples, and as a matter of course, may be modified without departing from the spirit of the invention.

For example, snubber circuits 3, 3a, and 3b can be parallelly connected to secondary winding S of transformer T. Even when such a snubber circuit is connected in this way, since secondary winding S is electromagnetically coupled to primary winding P, the snubber circuit is parallelly connected to primary winding P in an AC manner, achieving the surge absorption effect.

According to the technique disclosed in Patent document 1, the flyback voltage and the surge voltage are applied to the snubber circuit in the whole region from no-load to heavy load, generating a loss in the entire load region of the snubber circuit according to load power. Especially in recent years, for power saving, it is essential to reduce power consumption at stand-by and light load operation and thus, a loss in the snubber circuit at stand-by or light load operation cannot be dismissed.

The above embodiments can provide a snubber circuit capable of reducing a loss at stand-by or light load operation.

What is claimed is:

1. A snubber circuit that absorbs a surge voltage generated in a transformer of a switching power supply, the snubber circuit comprising:
a diode;
a zener diode electrically connected to the diode; and
a first capacitor electrically connected to the zener diode, wherein
the diode, the zener diode, and the first capacitor are serially connected such that, at occurrence of the surge voltage, the diode operates in a forward direction and the first capacitor is charged with the surge voltage via a breakdown voltage of the zener diode, and
the diode has reverse recovery time that is longer than a half of a cycle of a ringing voltage generated in a winding of the transformer and is in a range of 125 ns to 7 μs.

2. The snubber circuit of claim 1, further comprising a second capacitor connected to the zener diode, a capacitance of the second capacitor being in a range of 100 pF to 1000 pF.

3. The snubber circuit of claim 2, wherein a sum of the capacitance of the second capacitor and a junction capacitance of the zener diode is in a range of 400 pF to 1000 pF.

4. The snubber circuit of claim 2, wherein a capacitance of the first capacitor is equal to or more than the capacitance of the second capacitor.

5. The snubber circuit of claim 1, wherein a junction capacitance of the zener diode is in a range of 100 pF to 1000 pF.

6. The snubber circuit of claim 1, further comprising a resistor serially connected to the zener diode, a resistance value of the resistor being in a range of 10Ω to 470Ω.

7. The snubber circuit of claim 1, wherein the breakdown voltage of the zener diode is larger than a flyback voltage of a primary winding, the flyback voltage determined based on a turns ratio of the primary winding to a secondary winding of the transformer and an output voltage.
